(19) United States
(12) Patent Application Publication
(10) Pub. No.: US 2019/0137027 A1
(43) Pub. Date: May 9, 2019

(54) IN-SITU DEPLOYMENT DEVICE

(71) Applicant: 3M INNOVATIVE PROPERTIES COMPANY, St. Paul, MN (US)

(72) Inventors: Ian Robinson, Northallerton (GB); Andrew R. Henry, Leicestershire (GB); Wayne S. Jobling, Northallerton (GB)

(21) Appl. No.: 16/096,506

(22) PCT Filed: Apr. 25, 2017
(86) PCT No.: PCT/US2017/029314

§ 371 Date: Oct. 25, 2018

(30) Foreign Application Priority Data
Apr. 28, 2016 (EP) 16167530.1
May 31, 2016 (GB) 1609516.8

(51) Int. Cl. F16L 55/165; F16L 55/163; F16L 55/18; F16L 58/10

(52) U.S. Cl. CPC F16L 55/1653; F16L 58/1027; F16L 55/18; F16L 55/163

(57) ABSTRACT

An in-situ deployment device (20) for transporting an expandable sleeve (4) inside of a pipe (1, 2) and for applying it in on the inside of the pipe (1, 2), wherein the expandable sleeve (4) comprises a backing layer (5) and an adhesive layer (6) and wherein the adhesive layer (6) faces the outside when the sleeve is positioned on the deployment device (20) while being transported through the pipe (1, 2), the deployment device (20) comprising: —an inflatable section (21) for carrying and expanding the expandable sleeve (4) and —a positioning section (22) for positioning the deployment device (20) at the correct location inside of the pipe (1, 2), wherein the inflatable section (21) and the positioning section (22) are connected such with each other that the two sections (21, 22) can move relative to each other.

The invention relates to an in-situ deployment device for transporting an adhesive sleeve inside of a pipe and applying it on the inside of the pipe.

Infrastructure pipelines, vessels or conduits that carry fluids such as potable water, gas and wastewater deteriorate over time due to their extensive use. This deterioration can lead to leaks and bursts resulting in costly damage if the pipelines are not maintained. Since these pipelines are typically located underground and provide essential utilities, maintenance and rehabilitation are preferably performed with as minimal disruption to service as possible. Several methods for performing in-situ maintenance and rehabilitation on these pipes, known as trenchless methods, have been developed. One such method involves feeding an applicator device through the pipe to spray a material along the interior surface of the pipe. The material then hardens to form a new, interior liner surface or protective coating to seal cracks and strengthen the existing pipelines. This technique is known as in-situ spry lining technique.

One technique for spray coating the interior surface of a pipe involves centrifugally spraying a liquid liner, or resin composition, with a hole-patterned cone. A device for applying a coating according to this technique is for example disclosed in WO 2014/105630 A1. A method of forming a coating on the internal surface of a drinking water pipe is also disclosed in GB 2 42 634 A.

A significant challenge in the above described in-situ spray lining techniques for rehabilitation of pipelines infrastructure is that the liquid material has limitations in its ability to fill or span circumferential discontinuities such as for example those associated with mechanical joints in the pipeline system, gaps or holes. Consequently additional treatments of those discontinuities have been developed in order to guarantee a continuous end to end solution.

If for example structural rehabilitation of a pipe infrastructure is undertaken, it is essential that the installed lining is effectively continuous. This can be of particular importance in the case of natural gas distribution pipelines where any discontinuity in the installed lining can act as site of “gas tracking” between the lining and the hose pipe wall.

Current commercial solutions for the spanning of gaps, holes and joints include a number of alternative technologies. The following provide a brief overview of some of these technologies.

Chemical grout systems are often two component liquids that are delivered to the joint or defect through umbilical lines attached to a bladder packer. The packer inflates at the joint/defect site and material is pumped into the remaining annular space. The system is allowed to cure and then the packer is deflated and moved to the next joint/defect point. Chemistry in these grouts is often a moisture cure polyurethane (e.g. a MDI-based isocyanate with water and accelerator), or acrylate gel solution (acrylamide with crosslinking agents). Adhesion to the pipe is poor in most cases and the system is most effective when repairing holes that vent to outside the pipe. Reparation of recessed areas of a pipe that are sealed, for example joints, is difficult because the material is pumped into the annular space with no external pressure release of air. This may lead to pockets of unfilled space.

Mechanical sleeve solutions are also known. They comprise a metal or polymer sleeve that is delivered into the pipe in a closed form. Once at the joint or defect site, the sleeve is expanded and locked into place to seal the joint or defect. The locking mechanism is typically mechanical. The expansion technique can be with a bladder packer, a hydraulic press or in larger diameter pipes by manual engagement of the expansion and locking mechanism. Sleeves for pressure pipe applications are typically composed of steel, with a rubber backing to provide the seal. They can also be deployed in conjunction with a chemically curing sealant to further improve the sealing integrity.

Examples of such systems are for example disclosed in the following references. U.S. Pat. No. 4,069,573 discloses a hydraulic actuated deployment device providing a radial outward force to position and secure a mechanical repair sleeve within a pipe. U.S. Pat. No. 4,713,870 discloses a pipe repair sleeve apparatus, wherein the sleeve comprises a shape memory alloy. The apparatus comprises fixture means that extend outside the pipe to be repaired and is required for properly positioning the apparatus inside of the pipe. U.S. Pat. No. 5,465,758 discloses an apparatus for applying a sealing sleeve inside of a pipe. The apparatus comprises a driving cart and a mounting cart. The driving cart comprises a television camera and spotlights in order to direct the mounting cart to a leakage point of a pipe to be sealed. The mounting cart is provided to travel inside the pipe and has an undercarriage in form of an elongated-rectangular base plate. It also provides a widening device for widening the sealing sleeve. The driving cart and the mounting cart are connected to each other via a coupling device. U.S. Pat. No. 5,119,862 discloses the use of an inflatable airbag to expand a coiled sealing sleeve. And U.S. Pat. No. 5,725,026 uses a torpedo or displacement device to expand a coiled sealing sleeve.

An alternative technique for the in-situ rehabilitation of pipes is the cure in place pipe (CIPP). This solution comprises a felt sock or woven scrim that is impregnated with a curable resin and delivered to the pipe. The sock is then filled with hot water or steam and the resin cures to form a composite sleeve within the pipe. Typically resin system are unsaturated polyester, vinyl ester or epoxy resin. The same technique can be employed to effect spot repairs, wherein the felt or scrim is wetted out with resin by hand and then wrapped around a bladder packer, delivered to the joint or defect site, expanded, allowed to cure and then the packer is deflated leaving the composite patch at the joint or defect site.

Another possibility to repair a pipeline or to prepare the pipeline before spray coating it, is disclosed in US 2009/283 212 A1. According to the solution described in this patent application a hardenable, partially hardened, flat insert mat or prepreg is used to seal a pipe. The following steps are disclosed for this method: adhesive is applied at least to the outer surface of the insert, adhesive is introduced between two superposed end regions of the insert and the insert is given the form of a cylinder jacket. The inset is then placed on an elongated balloon, a part of the insert is placed against the balloon and its jacket continuously covers at least a partial area of it, and the remaining region of the insert which does not adjoin the balloon is turned into a loop and pressed against the outer surface of the insert. The balloon with the insert is then inserted into the pipe and positioned at the leak or weak location. The balloon is inflated such that the insert is pressed against the inside of the pipe and the adhesive is hardened.

While several of these technologies have been evaluated as a means to enable a continuous spray lining, each technique may—depending on the actual application—have limitations if deployed prior to spray lining.

In view of the above applicant has developed a reliable, cost effective method of sealing a pipe section to enable continuous spray lining. This method has been filed as European Patent Application EP 16167530.1 on Apr. 28, 2016, its priority is claimed by this application, and comprises the following steps:
providing an inflatable packer or bladder,
providing an expandable sleeve with a backing layer and an adhesive layer,
wrapping the expandable sleeve around the packer or bladder with the adhesive layer facing the outside,
inflating the inflatable packer or bladder until it reaches a first diameter, wherein the first diameter is smaller than the inner diameter of the pipe section, thereby expanding the expandable sleeve,
inserting the inflated packer or bladder with the expanded sleeve into the pipe until it reaches the pipe section to be sealed, and
further inflating the packer bladder until it reaches a second diameter, thereby further expanding the expandable sleeve,
wherein the second diameter is reached when the expanded sleeve touches the inner diameter of the pipe section.

Bladder and packer are in the following both equally used to describe the flexible inflatable part of a deployment device according to the invention.

The method basically provides the following steps: the expandable sleeve described above is wrapped around a bladder with the adhesive layer facing the outside. The adhesive is a strong pressure sensitive adhesive, which allows for good adhesion of the sleeve on the inside of the pipe. The strong adhesive brings also the risk to be contaminated during transfer through the pipe. In order to assure reliable application of the adhesive sleeve it is critical that the sleeve gets moved through the pipe without touching the inside of the wall. According to the above process the bladder is then inflated until it reaches a first diameter that is smaller than the inner diameter of the pipe section, thereby inflating the expandable sleeve. The expanding of the expandable sleeve in this step helps to hold the sleeve in position on the inflatable bladder, which is not tacky at the inside onto the bladder, such that the sleeve does not move relative to the inflatable bladder.

The bladder with the expanded sleeve wrapped around it is then inserted into the pipe until it reaches the pipe section to be sealed. Finally the inflatable bladder is inflated until it reaches a second diameter, thereby expanding the expandable sleeve, wherein the second diameter is reached when the expanded sleeve touches or contacts the inner diameter of the pipe section. In order for the method to work reliably it is important that the first diameter of the inflatable bladder is not only smaller than the inner diameter of the pipe section but also smaller than any diameter of the pipe along which the inflatable bladder is moved to get to the pipe section to be sealed.

In view of the above, a need exists to provide a deployment device for applying an expandable sleeve with a backing layer and an adhesive layer on the inside of a pipe following the above process to enable continuous spray coating or lining of a pipe. The deployment device needs to be able to transport the expandable sleeve through the pipe, with the adhesive layer of the expandable sleeve facing the outside. It is important that the sleeve gets transported through the pipe without touching the inside of the pipe, especially if the pipe sections that build the pipe are not ideally aligned with each other and provide for example offset arrangements or angled arrangements at pipe joints.

The invention relates to an in-situ deployment device for transporting an expandable sleeve inside of a pipe and applying it on the inside of the pipe, wherein the expandable sleeve comprises a backing layer and an adhesive layer and wherein the adhesive layer faces the outside when the sleeve is positioned on the deployment device while being transported through the pipe, the deployment device comprising:
an inflatable section for carrying and expanding the expandable sleeve and
a positioning section for positioning the deployment device at the correct location inside of the pipe,
   wherein the inflatable section and the positioning section are connected such with each other that the two sections can move relative to each other.

The pipe to be sealed can be any kind of pipe such as for example a gas pipe, e.g. a natural gas pipe, or a fluid pipe, e.g. a drinking water pipe, or any other kind of industrial pipe. The pipe section can have any kind of inner diameter. Common gas or water pipes provide an inner diameter between 75 mm and 300 mm, preferably between 100 mm and 200 mm. Those pipes may provide offset joints. They may for example provide an offset in a joint of up to 10 mm or even more. They may also provide an angled offset with an angle of up to 5 degree or even more.

The expandable sleeve used in the invention can be any kind of sleeve with at least a backing layer and an adhesive layer, wherein the backing layer needs to provide enough abrasion and tear resistance in order to resist any possible mechanical damage, e.g. during a lining process. It may further be conformable or elastic enough to be expanded during the sealing process of the invention. The backing layer can also provide a low surface energy in order to prevent or minimize localized adherence of the lining material. The adhesive material may be any compound that adheres or bonds two or more substrates together. The adhesive may come from either natural or synthetic sources. For this specific application it may be conformable, in order to enhance the conformability of the sleeve. It may for example be a pressure sensitive adhesive, wherein a pressure sensitive adhesive may be defined as an adhesive that is permanently tacky at room temperature and that sticks to almost all surfaces. The sleeve may also comprise additional layers.

The present invention provides a deployment device for transporting an expandable sleeve inside of a pipe and for applying it on the inside of the pipe, wherein the expandable sleeve provides a backing layer and an adhesive layer. The deployment device according to the invention is able to reliably and cost effectively transport and apply the sleeve inside of the pipe. The expandable sleeve may be used to prepare the pipe for a continuous spray lining process.

The deployment device transports the expandable sleeve with its adhesive layer facing the outside. If the deployment device is inserted into a pipe to be sealed, the adhesive layer faces the inner wall inside of the pipe. This is necessary to be able to adhere the expandable sleeve to the inner wall at the inside of the pipe.

According to the invention the deployment device comprises an inflatable section for carrying and expanding the expandable sleeve and a positioning section for positioning the deployment device at the correct location inside of the pipe, wherein the inflatable section and the positioning section are connected such with each other that the two sections can move relative to each other. As already mentioned above, pipe sections that form a pipe are not always ideally aligned with each other. It may be possible that the pipe comprises offset arrangements or angled arrangements at pipe joints. The offset arrangements may for example be as big as 10 mm or more and the angled arrangements may for example be as big as 5 degrees or more. When the deployment device with the expandable sleeve travels along the inside of the pipe it passes several joints. Therefore it is necessary that the components of the deployment device are dimensioned such that they can be moved along the pipe with the expandable sleeve being positioned on the inflatable section with the adhesive layer of the sleeve facing the outside and without touching the pipe at any time during the travel through the pipe. By providing a flexible connection between the inflatable section and the positioning section the deployment device can be moved in a more flexible manner through the pipe which allows reliably transporting the expandable sleeve without it touching the inside of the pipe prior to bladder expansion. It is possible that the inflatable section and the positioning section each can provide a certain length and that the entire deployment device can still be moved thought the pipe without the adhesive layer of the sleeve touching the inner wall of the pipe when the connection between the two sections is not completely rigid.

The inflatable section and the positioning section may be connected with each other by at least one rod or any other kind of suitable means as long as they are suitable to connect the two sections with each other in a flexible manner while at the same time maintaining the distance between them. The rod may be made out of metal, such as for example steel or aluminium or any other kind of suitable material. The rod may comprise a thread in order to be able to adjust the distance between the inflatable section and the positioning section. Depending on the required stability one, or two or more rods may be used to connect the two sections to each other. Good results have been achieved by using two rods, both being mounted on one side of the two sections. The rods may for example provide a diameter of 6 mm. They may be biased to one side of the two sections, i.e. at approximately 5 and 7 o'clock if laid out with the rods at the bottom of the deployment device. This allows the positioning section a degree of movement vertically relative to the inflatable section when travelling through the pipe. The flexibility is relative when compared to if several rods located equally around the circumference or a solid metal piece would be used for connecting the two sections.

The rods may be threaded to allow adjustment of the distance between the two sections. The rods may be screwed into threaded holes at the end caps of the inflatable section and/or the positioning section. They may for example be hold in place with one or more moveable nut on each side of the end caps and/or sections.

The two sections of the deployment device may be connected with each other by two rods, wherein the two rods are positioned adjacent each other on one radial side of the deployment device. This arrangement allows some flexibility between the two sections.

The positioning device may be made out of metal, e.g. aluminium or any other kind of suitable material. It may comprise a camera and optionally a light source. The camera may have its own light source, e.g. a LED light source. If the camera does not have its own light source, a separate light source may be necessary. The camera may be a high resolution camera. The camera and light source are aimed directly at the inflatable section to view to help position the deployment device as will be described in detail further below. The camera can either be dedicated and integral to the deployment device or attached when required. A screen outside the pipe shows the captured image from the camera to the user in real time. A glass fibre umbilical cable may contain the camera cables.

The positioning section of the deployment device may also comprise means for centering the positioning section. The positioning section may for example be supported on brush strips to centre the camera in the pipe and minimise risk of jamming. Other possible embodiments for the centering means will be described further below.

The inflatable section of the deployment device may comprise an inflatable bladder and two end caps one on each side of the bladder. The inflatable bladder may also be described as an elongated balloon or a packer. Inflatable pipe stoppers may be used as the inflatable section of the deployment device. The inflatable section may be made out of rubber. It may comprise ribs to hold the expandable sleeve in place. The end caps of the expandable section may be made out of metal, for example out of aluminium. They may also be made out of any other suitable material, that is able to hold the packer in position and that is not too heavy to be transported through a pipe. The expandable sleeve is wrapped around this section and inflated and pressed onto the inside pipe wall during installation.

The dimensions of the inflatable section are selected such that the deployment device is suitable to transport the expandable sleeve with the adhesive layer facing the outside through the pipe without the adhesive sleeve touching the pipe prior to full inflation of the bladder. This allows the deployment device to transport the sleeve through a pipe that comprises joints with offsets of up to 10 mm or more and that is angled by up to 5 degree or more. It may for example be sized appropriately with respect to the sleeve to minimise its overall length. This improves the ability to move the deployment device through the pipe without its center area (area which is wrapped in the adhesive sleeve) touching the pipe walls.

The inflatable section is important to ensure that the sleeve successfully adheres to the pipe wall. The inflatable section must for example be able to:
inflate from around 65 mm to 100 mm for a 4″ (101.4 mm) pipe system
inflate from around 90 mm to 150 mm for a 6″ (152.4 mm) pipe system, etc.
transfer pressure from air to the sleeve

A possible supplier of these inflatable bladders is for example the company Allpipe, UK, which sell these as “pipe stoppers,” that are usually used to seal a pipe in order to allow opening of the pipe for repair purposes for example. Commercially available packers that are used to apply resin impregnated sleeves inside of pipes may not suitable for the deployment device according to the invention since they are usually too long and do therefore not fulfil the above described requirements.

If the inner diameter of the pipe to be sealed is for example 100 mm, the inflatable section with needs to be at least as long as the sleeve that it needs to transport, which is for example 200 mm. For this specific pipe diameter the inflatable section may comprise a total length of for example 370 mm. If the pipe to be sealed has a larger or a smaller diameter, longer or shorter inflatable sections may be required. In general the length of the inflatable section needs to be minimised to make sure that the deployment device may be moved through the pipe without touching the inner wall of the pipe during this movement.

The inflatable packer may comprise a diameter of 60% to 70% of the inner diameter of the pipe when being moved with the expandable sleeve towards the location that needs to be sealed.

The deployment device according to the invention may comprise an inflatable section with end caps that have means for centering the inflatable section. The means for centering the inflatable section may for example be brushes. The brushes may be held in channels of the end caps e.g. with grub screws. The length of the brushes may be designed with interference to the pipe wall so the inflatable section is centered inside of the pipe. The end caps may, for example, be held onto the inflatable bladder by a slight interference fit and rubber adhesive. Alternative embodiments for the centering means are described below.

The inflatable section may also comprise at least one end cap with a laser positioning system, for example the end cap facing the positioning section. The camera of the positioning device may be directed towards the laser positioning system. The laser may be selected such that it projects a line onto the inside wall of the pipe. It may be powered by an internal battery. Other kind of powering systems whether inside or outside the deployment device are possible as well. It may be possible to turn the power on and off using a switch. The laser is used to accurately locate a joint in conjunction with the camera. It may for example create a 10 mm line running circumferentially around the pipe. The camera may be directed towards the inflatable section of the deployment device to view the laser and pipe wall between the camera mount and the end cap. Once the laser is directly pointing to the joint—the camera picks up the disappearance/displacement of the laser within the joint—the deployment device can be pulled a known distance so that the expandable sleeve is pulled to the place where it needs to be applied in order to completely cover the joint. The laser may be class 2 rated and may use a divergent lens in order to be safe for use without requiring eye protection.

Other detection systems may be used as well, such as for example a laser distance sensor to profile and detect a joint or a switch which physically touches the side wall and detects the joint.

The deployment device according to the invention may also comprise an umbilical cable for transferring information and for moving the device inside of the pipe. This cable provides two functions which are transferring information and movement of the deployment device. The cable may comprise a glass fiber cable or any other kind of suitable cable that is able to fulfil the above mentioned two functions.

The deployment device may also comprise a steel cable for moving the device inside of the pipe. The steel cable may be mounted on the opposite side of that end, where the umbilical cable is mounted. With such a construction it is possible to move the deployment device into both directions of the pipe. Therewith it is possible to use both pipe ends as entry or exit portions.

The deployment device may also comprise an airline for transporting air through the pipe for inflating or deflating the inflatable section. The airline may be a 6-8 mm reinforced airline, for example a 6 mm (¼″) single wire paint line. The small diameter reduces the volume of air within the pipe and hence the time taken to pressurise and exhaust the inflatable section.

According to the invention cushioning elements may also be used as centering devices for the positioning section and/or the inflatable section. The cushioning elements are designed such as to adjust the radial extension of the centering means thereby compensating any unevenness within the pipe. It is also possible that the centering means provide adjustably extendable centering arms for reliably adapting to different diameters of a pipe. The number of the centering arms may for example be 3 or more. One or more of the centering arms may provide an adjustably extendable arm with a first tapered mounting block and a second tapered mounting block, the two mounting blocks being arranged such that by moving them relative to each other the radial extension of the centering arm may be shortened or extended in a certain range. Two tapered blocks provide a robust and reliable system for an extendable centering arm, since a good guidance of one block relative to the other block may be provided. In addition, this system is a space saving system. By selecting the angle for the taper of the two mounting blocks the accuracy of the system can be adjusted as well. The second tapered mounting block may be moveable in an axial direction of the pipe.

The cushioning element may comprise a brush. A brush as a cushioning element may adjust the radial extension of the centering means and thereby compensate any unevenness in the pipe. Any other kind of cushioning element may be used as well, such as for example “spring skids”. The brush may comprise synthetic fibers such as for example nylon fibers. They are easy to clean and robust. They can be selected such that they provide the stiffness needed for the cushioning effect. Any other kind of fibers or strips are possible as well.

An external control system may be used by an operator to inflate and deflate the device. All pneumatic controls may be located off the deployment device in order to reduce the complexity of it and the weight.

Important features of the control system may be:
air supply is regulated down to required pressures (dependent on inflatable section specification, recommended 2 bar or greater)
air supply is split into a low pressure (approx. 0.1 bar for partial inflation to hold sleeve in position) and high pressure (up to 15 bar preferably between 2 and 5 bar for application of sleeve)
three valves can be manually or electrically operated to control air supply of the deployment device

The following stages can be realized:
system off
low pressure inflation
high pressure inflation and
exhaust air from inflatable section

A method of sealing a pipe section that can be applied with the above described deployment device may provide the following embodiments. The method according to the invention may comprise the step of further inflating the packer to provide a radially applied pressure onto the expanded sleeve after it has touched or contacted the inner wall of the pipe section to be sealed in order to facilitate adequate adhesion of the sleeve at the pipe. Depending on the strength of the adhesive, the pressure may be adjusted.

The radially applied pressure onto the expandable sleeve in its expanded stage may be up to 15 bar, preferable between 2 to 5 bar. The pressure in this passage refers to the pressure inside of the packer.

The radially applied pressure onto the expanded sleeve may be maintained for two to five minutes. Depending on the adhesive layer it is also possible to maintain the pressure for less than two or more than five minutes.

After radially pressurizing the sleeve in its position the packer may get deflated and removed out of the pipe. After having sealed all kind of circumferential discontinuities inside of a pipe it is possible to rehabilitate the pipe by internally spray coating or spray lining it (in-situ spray coating or spray lining of the pipe).

The adhesive layer of the expandable sleeve may be selected such that it provides a strong enough adhesion force to hold the expandable sleeve in its expanded stage at the inner wall of the pipe section to be sealed. After the inflatable packer is deflated the expandable sleeve is adhered to the inner wall of the pipe section.

The adhesive layer of the expandable sleeve may comprise a 90 degree peel adhesion based on ASTM D-3330 April 2010 between 20 and 50 N/cm with the following parameters set: stainless steel substrate, 72 hour room temperature with 3M™ VHB™ Tape 5925 tape to attach aluminium peel strip backing; 3M™ Adhesion Promoter 111 used on substrates.

The adhesive layer of the expandable sleeve may also comprise an initial 180 degree peel adhesion based on ASTM D-1000 October 2010 between 20 and 150 N/100 mm with the following parameters set: 20 min. dwell at R.T. 12″/minute peel on the following substrate surfaces: aluminium, stainless steel, glass, polyurethane paint, acrylic lacquer paint and acrylic enamel paint.

The pipe section to be sealed may comprise a hole, a gap between two pipes joining each other or any other kind of gap or circumferential discontinuities or hole.

The backing layer of the expandable sleeve may be a polymeric backing layer. It may comprise polyurethane, polyethylene or co-polymers thereof as well as synthetic rubber or PVD. Preferred backing materials may include elastomeric polyurethanes, polyethylene-acrylic ionomers and ethylene-propylene rubber or any other conventional backing material. The adhesive layer of the expandable sleeve may comprise an acrylic compound, a rubber compound and/or a mastic compound. The adhesive layer may optionally incorporate a foam carrier. A mastic adhesive is a very strong bonding agent used in many commercial and industrial settings, but is perhaps most popular for setting tiles and sealing windows, walls, and ceilings in building construction. It is traditionally derived from the resin of the mastic tree, which is where it gets its name, though it is commonly manufactured synthetically as well. Depending on the application it is generally available in thin liquid, thick glue, or paste form. It can quickly and permanently bind many different materials together, though in most cases it works best on hard, non-porous surfaces. Over time it can and sometimes will seep into cracks and crevices, which can lead to discoloration and general weakening.

Depending on the selected adhesive and polymer backing, the thickness of the adhesive may range from 0.2 mmm to 2.0 mm. The thickness of the backing may range from 0.1 mm to 1.0 mm. the total thickness of the sleeve may be between 0.3 mm to 3.0 mm.

The expandable sleeve may be provided as a flat sheet, pre-cut into a rectangular shape. The rectangular sheet may be for example 200 mmm wide (dimension along the axis of the pipe. The width may range from for example 200 mm to 300 mm in order to overlap the joint on either side. The length of the sheet—which corresponds to the circumference of the deflated packer plus an overlap—may be at least 3.14× the inner diameter of the pipe plus an overlap. It may for example range from 200 mm to 950 mm, depending upon the inner diameter of the pipe to be rehabilitated. It preferably ranges in its widths from 310 mm to 620 mm. The pre-cut rectangular piece may provide two opposing end regions.

When the expandable sleeve is positioned around the inflatable packer, the two opposing end regions may overlap each other thereby building or providing a cylindrical sleeve. When the inflatable packer gets inflated it expands the cylindrical sleeve, which means that the diameter of the sleeve gets larger. The overlapping end regions stay on top of each other during this expansion without moving relative to each other.

In order to provide a reliable method of sealing a pipe section, the overlapping ends may overlap each other by 10 to 40 mm so as to form a cylindrical sleeve.

With an overlap of this size it is guaranteed that during the expansion step the overlapping end regions stay on top of each other without moving relative to each other.

It is also possible to provide the expandable sleeve in an elongated substantially cylindrical sleeve with a diameter that fits to the inner diameter to the pipe. Such cylindrical sleeve would not provide any overlapping areas. It would only have to be moved onto the packer in its first stage (when the first diameter is reached). It would then be expanded when the packer is brought into its second stage (when the second diameter is reached).

The invention will now be described in more detail with reference to the following Figures exemplifying particular embodiments of the invention:

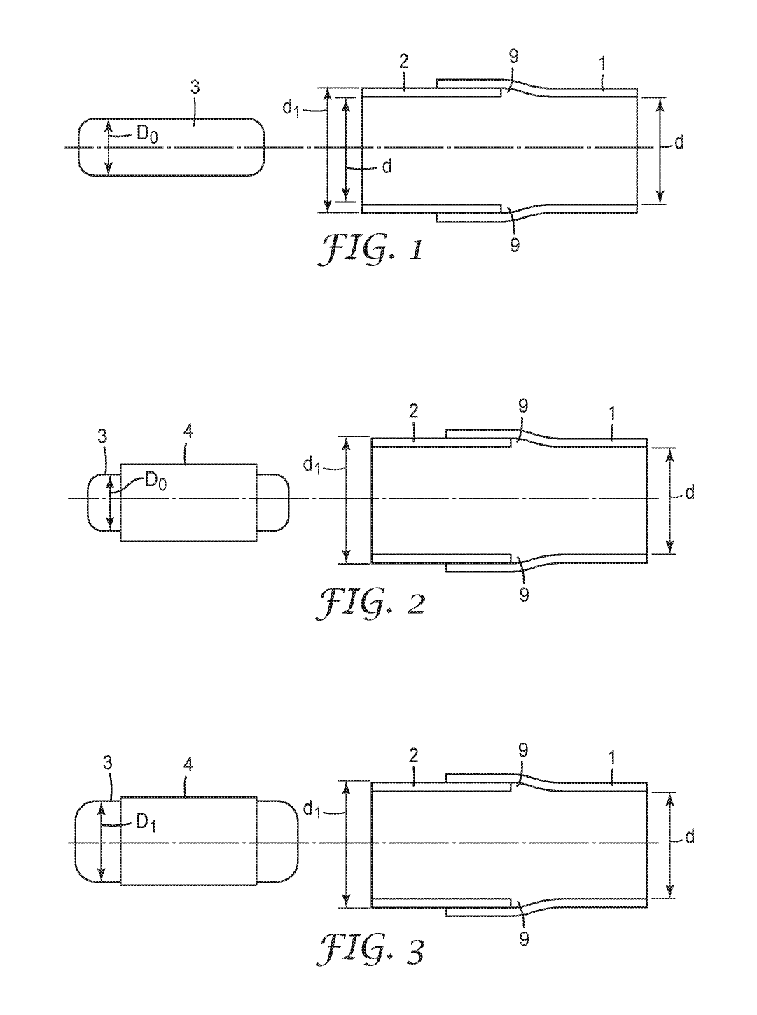

FIG. 1 is a cross-sectional, schematic view of a pipe section with an inflatable section of a device according to the invention outside of the pipe section, the inflatable section comprising a diameter Do;

FIG. 2 is a cross-sectional, schematic view of a pipe section with an inflatable section of a device according to the invention outside of the pipe section, the inflatable section comprising a diameter Do, the inflatable section further comprising an expandable sleeve being wrapped around the inflatable section;

FIG. 3 is a cross-sectional, schematic view of the pipe section of FIG. 1 with the inflatable section of a device according to the invention outside of the pipe section, the inflatable section comprising a diameter D₁, D₁ being bigger than Do and smaller than the inner diameter of the pipe d;

FIG. 4 is a cross-sectional, schematic view of a pipe section of FIG. 1 with the inflatable section with its diameter D₁ being inserted into the pipe;

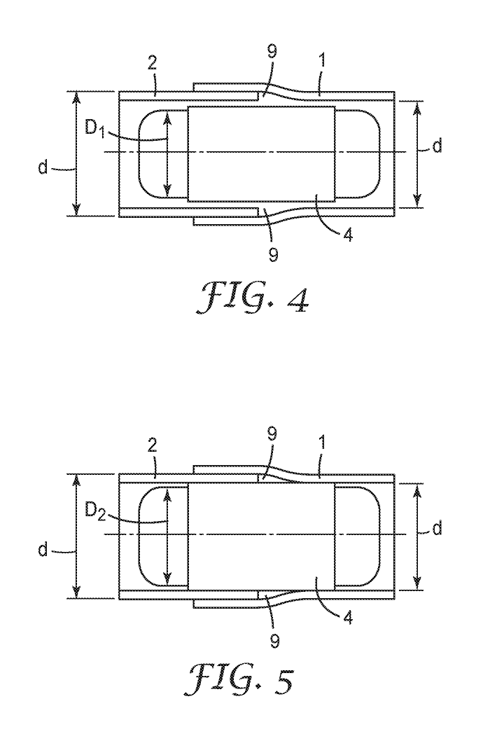

FIG. 5 is a cross-sectional, schematic view of a pipe section of FIG. 1 with the inflatable section being inserted into the pipe and the inflatable section being inflated to a diameter D₂ equal to the inner diameter of the pipe section;

FIG. 6 is a cross-sectional, schematic view of an expandable sleeve wrapped around the inflatable section;

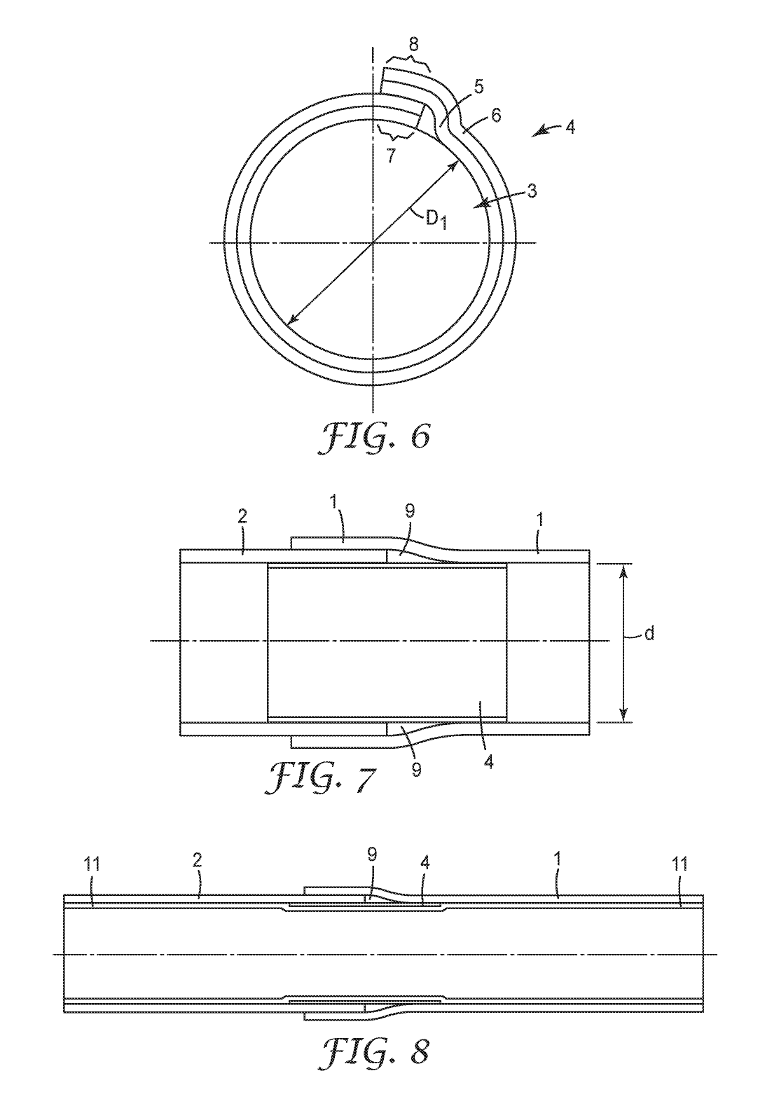

FIG. 7 is cross-sectional, schematic view of the pipe section of FIG. 1 with the expandable sleeve being attached to the inner wall of the pipe section;

FIG. 8 is a cross-sectional, schematic view of a larger part the pipe section of

FIG. 1 with the expandable sleeve being attached to the inner wall of the pipe section and a coating being provided inside of the pipe section covering its inner wall as well as the sleeve;

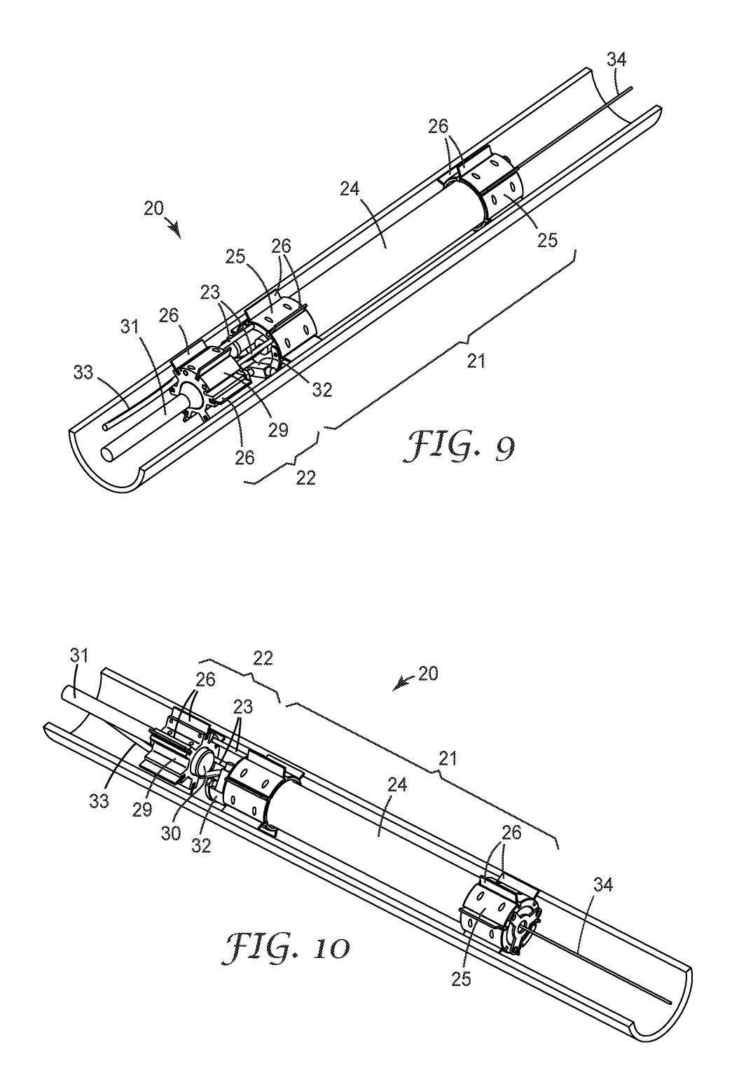

FIG. 9 is a three dimensional view of one embodiment of the deployment device according to the invention within a pipe section;

FIG. 10 is a three dimensional view of the device shown in FIG. 9 within a pipe shown from another angle;

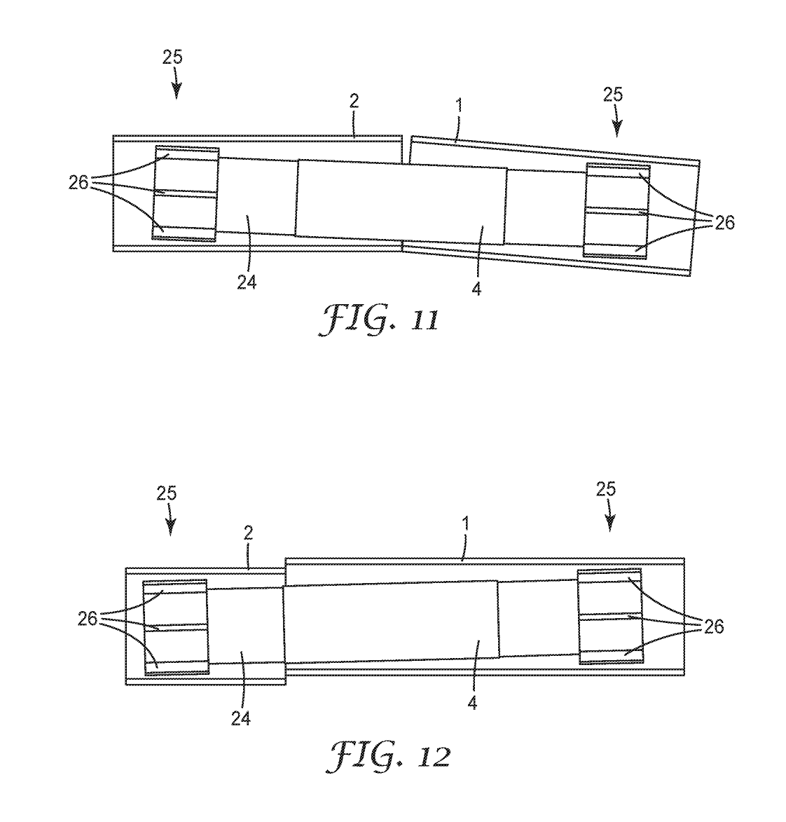

FIG. 11 is a cross-sectional, schematic view of the inflatable section of a device according to the invention inside of a pipe at the location of an offset pipe joint;

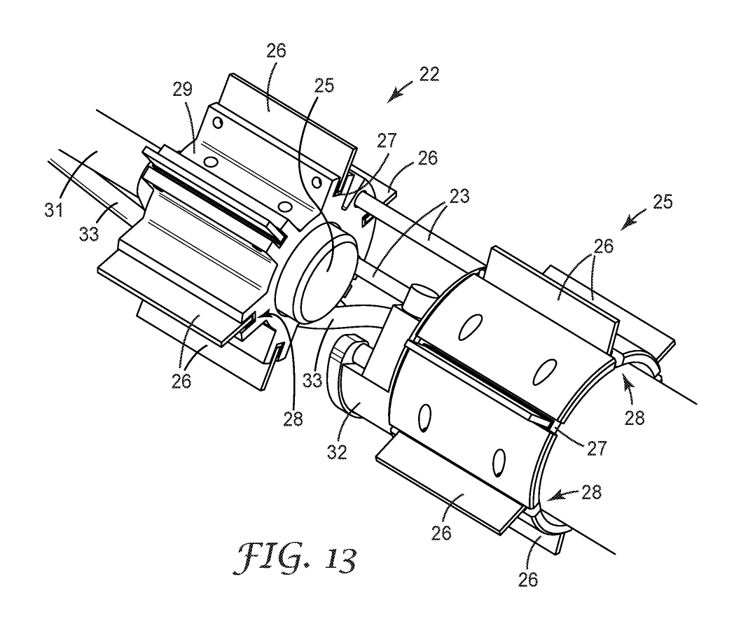

FIG. 12 is a cross-sectional, schematic view of the inflatable section of a device according to the invention inside of a pipe at the location of another kind of offset pipe and

FIG. 13 is a three dimensional view of the connection between the positioning section and the inflatable section.

Herein below various embodiments of the present invention are described and shown in the drawings wherein like elements are provided with the same reference numbers. Before describing the deployment device according to the invention a method of sealing a pipe section that can be applied with the deployment device according to the invention will be described with reference to FIGS. 1 to 8.

FIG. 1 is a cross-sectional, schematic view of a pipe section. The pipe section is a joint of two ends of pipes 1 and 2. The inner diameter of the pipes 1 and 2 is d, wherein the end section of the pipe 1 provides an enlarged inner diameter di to receive an opposing end section of the pipe 2. In that joint a gap 9 may exist between the end of pipe 2 and the enlarged section of pipe 1. The materials used in in-situ maintenance procedures, e.g. in in-situ spray coating processes may have limitations in their ability to fill or span circumferential discontinuities, such as for example those discontinuities showed in FIG. 1, a gap 9 due to a joint of pipes. In order to prepare the pipe section for the in-situ spray coating process, the herein following method provides a pre-treatment of the pipe.

For the pre-treatment a deployment device according to the invention is used that provides an inflatable section that may be adapted in its diameter. The inflatable section also provides mechanical means for moving it into, along the pipe and back out of the pipe as will be described below in more detail. In addition, the inflatable section provides means for centering and positioning as will also be described in more detail below. These means are not shown in FIGS. 1 to 8 to ensure clarity in the drawings.

FIG. 1 also schematically shows an inflatable section 3 of the deployment device according to the invention outside of the pipe section. The inflatable section is in an uninflated stage and provides a diameter Do, which is smaller than the diameter d of the pipes 1 and 2. It may also be smaller than 70% of the diameter d for the pipes 1 and 2.

FIG. 2 is a cross-sectional view of the same pipe section of pipes 1 and 2 and the inflatable section 3, wherein the inflatable section 3 is in its uninflated stage with a diameter Do. An expandable sleeve 4 is wrapped around the inflatable section 3 such that the end portions 7 and 8 of the sleeve 4 overlap each other (see FIG. 6).

FIG. 3 is a cross-sectional view of the same pipe section of pipes 1 and 2 and the inflatable section 3, wherein the inflatable section 3 has now been inflated up to a first diameter D₁, which is larger than Do but still smaller than d, the diameter of the pipes 1 and 2. The expandable sleeve 4, which is wrapped around the inflatable section 3, is stretched due to the inflation of the inflatable section 3. By slightly stretching the sleeve 4 it is guaranteed that the sleeve is positioned onto the inflatable section 3 and does not move relative to the inflatable section 3 during the next process steps.

As can be seen in FIG. 6 which shows a radial cross-section of the inflatable section 3 with an expandable sleeve 4 wrapped around the inflatable section 3, the sleeve 4 comprises two layers a backing layer 5 and an adhesive layer 6. The adhesive layer is facing the outside in FIG. 6. The sleeve 4 provides two opposing end regions 7 and 8, wherein the two opposing end regions 7 and 8 overlap each other when the sleeve 4 is wrapped around the inflatable section 3 of the deployment device according to the invention. Since the adhesive layer 6 is facing the outside of the sleeve 4 the overlapping end 8 becomes adhered to the overlapping end 7 due to the adhesive layer 6 of the overlapping end 7 getting in contact with the backing layer 5 of the opposing end 8. Thereby the sleeve 4 becomes fixed in its cylindrical shape.

Next the inflatable section 3 of the deployment device according to the invention with the thereon positioned sleeve 4 is inserted into the pipe until it reaches the pipe section to be sealed (see FIG. 4). The inflatable section 3 should be located centrally over the joint. Means of cameras may be used to ensure proper positioning as will be described in detail below. Lasers may optionally be used as well to aid in achieving proper location of the expandable sleeve 4 at the joint (see below). When the inflatable section 3 has reached the pipe section to be sealed it is inflated to the diameter D₂ which corresponds to the inner diameter of the pipes 1 and 2. Since the overlapping ends 8 and 7 are fixed relative to each other and do not move relative to each other, the sleeve 4 further expands until the adhesive layer 6 of the expandable sleeve 4 touches or contacts the inner walls of the pipes 1 and 2 (see FIG. 5).

The inflatable section 3 of the deployment device according to the invention may get even more inflated or pressurized in this position in order to provide a suitable pressure onto the expanded sleeve 4 to facilitate adequate adhesion of the sleeve 4 at the inner wall of the pipes 1 and 2. The pressure radially applied to the sleeve can be up to 15 bar, the pressure referring to the pressure inside of the inflatable section 3 of the deployment device according to the invention. Preferably it is between 2 and 5 bar. The pressure may be maintained for two to five minutes in order to assure reliable adhesion of the sleeve at the inner wall of the pipes 1 and 2. After this time the deployment device may be deflated and moved out of the pipe again. The inflatable section 3 of the deployment device may then be reloaded with another sleeve and deployed at the next spot to be sealed, e.g., at the next joint. When all spots are sealed the pipe is ready for an in-situ spray coating or lining which may lead to rehabilitation of the pipe.

FIG. 7 is a cross-sectional, schematic view of the pipe section with the joint of pipes 1 and 2 with the expanded sleeve 3 being adhered to the inner wall of the pipe section thereby extending over the gap 9, that exists due to the geometry of the pipe joint, wherein the pipe 1 provides an extended diameter to receive an end section of the pipe 2. The expanded sleeve 3 provides a seal for the gap 9 and therefore facilitates a reliable in-situ spray coating process. The result of a spray coating step can be seen in FIG. 8 which is a cross-sectional view of the pipe section of FIG. 7 with an additional layer of resin coating 11 the inner walls of the pipes 1 and 2 as well as the expanded sleeve 3 extending over the pipe joint.

Examples for sleeve materials that were tested and performed suitably are the following (all commercially available from 3M Company, St. Paul, Minn., US):
3M™ Polyurethane Protective Tape 8641
3M™ Polyurethane Protective Tape 8641 (perforated)
3M™ Rubber Mastic 2228
3M™ Extreme Sealing Tape 4411N
3M™ Extreme Sealing Tape 4412N
3M™ All Weather Flashing 8067
3M™ Cable Jacket Repair Tape 2234

The 3M™ (Aircraft Belly) Protective Tape 8641 is a 16-mil thick polyurethane coated with an aggressive, conformable 25-mil thick pressure sensitive acrylic foam adhesive.

The 3M™ Rubber Mastic 2228 is a conformable self-fusing rubber electrical insulating and sealing tape. It consists of an ethylene propylene rubber (EPR) backing coated with an aggressive temperature-stable mastic adhesive.

The 3M™ Extreme Sealing Tape 4411N, 4412N are tapes out of a family of single coated, pressure sensitive adhesive tapes designed for sealing applications. The backing on this tape is an ionomer film that is very tough yet flexible and abrasion resistant. The very soft and thick acrylic adhesive has excellent sealing properties. This single coated tape is designed to seal over an existing joint, seam or penetration. The adhesive is designed to adhere well to the ionomer film so that overlapping tape joints can be adhered while maintaining a strong seal.

The 3M™ All Weather Flashing 8067 is a self-adhered, waterproof flashing membrane designed for sealing around openings and penetrations in exterior walls. It has a unique acrylic pressure sensitive adhesive that aggressively sticks to all applicable surfaces and a proprietary backing with sealing function.

3M™ Cable Jacket Repair Tape 2234 is a two layer tape with an outer layer of vulcanized CSM rubber to provide outstanding chemical and environmental resistance. The inner layer is composed of flame-retardant mastic and acts as a moisture barrier which provides excellent adhesion to a variety of jacket materials.

| | | | | Adhesive | Robustness | Conformability |
|---|---|---|---|---|---|---|
| Tape | Thickness | Backing Type | Adhesive Type | Properties | of Backing | in Pipe |
| 3M Polyurethane | 1 mm | Polyurethane | Acrylic (foam carrier) | 5 | 9 | 9 |
| Protective tape | | | | | | |
| 8641 | | | | | | |
| 3M Polyurethane | 1 mm | Polyurethane | Acrylic (foam carrier) | 5 | 9 | 9 |
| Protective tape | | | | | | |
| 8641 (Perforated) | | | | | | |
| 3M Rubber Mastic | 1.65 mm | Rubber (EPR) | Mastic | 5 | 5 | 9 |
| 2228 | | | | | | |
| 3M Extreme | 1 mm | Ethylene/Acrylic co-polymer | Acrylic (foam | 9 | 9 | 9 |
| Sealing Tape | | | carrier) | | | |
| 4411N | | | | | | |
| 3M Extreme | 2 mm | Ethylene/Acrylic co-polymer | Acrylic (foam carrier) | 9 | 9 | 5 |
| Sealing Tape | | | | | | |
| 4412N | | | | | | |
| 3M All Weather | 0.13 mm | Acrylic | Acrylic | 9 | 5 | 1 |
| Flashing 8067 | | | | | | |
| 3M Cable Jacket | 1.5 mm | Rubber (EPR) | Mastic | 5 | 1 | 5 |
| Repair Tape 2234 | | | | | | |

The following is a description of the deployment device 20 according to the invention. FIGS. 9 and 10 are three dimensional views of one embodiment of the deployment device 20 according to the invention inside of a pipe section from two different angles. The deployment device 20 comprises an inflatable section 21 and a positioning section 22. The inflatable section 21 and the positioning section 22 are connected with each other by means of two rods 23 as will be described further below. The connection allows movement of the two sections relative to each other to allow some flexibility of the deployment device 20 when moving through a pipe.

The inflatable section 21 comprises an inflatable part or bladder 24 as well as two end caps 25 one on each side of the inflatable bladder 24. The inflatable bladder 24 may be made out of rubber and comprise a diameter that is variable in its size. It may for example be inflated from about 60% of the diameter of the pipe it is used for to 100% of the diameter of the pipe it is used for. The two end caps 25 may be made out of aluminium. They may comprise a receptacle to receive the ends of the inflatable bladder 24. They may also provide means for centering the inflatable section 21. The centering means may be arranged circumferentially around the end caps 25 and may be made out of cushioning elements like brushes 26. As can be seen in FIG. 13, the brushes may be held in u-shaped carriers 27 which are positioned in channels 28 within the end caps 25. It is also possible that the centering means are adjustable. Such an embodiment is not shown in the drawings.

The positioning section 22 also comprises a carrier 29 made of aluminium and centering means arranged circumferentially around the carrier 29. The centering means of the embodiment shown in FIG. 9 resemble to the brushes 26 of the inflatable section 21 just described. They comprise brushes 26 held in u-shaped carriers 27 which are held in channels 28 within the carrier 29.

For positioning the deployment device inside of the pipe the positioning section 22 provides a camera with an integrated light source 30. The camera 30 is mounted such on the positioning section 22 that it faces the inflatable section 21. The end cap 25 of the inflatable section 21 that faces the positioning section 22 provides a laser device 32. The laser device 32 generates a line onto the inside wall of the pipe. The laser is used to accurately locate a joint in conjunction with the camera. It may for example create a 10 mm line. The camera 30 may be directed towards the inflatable section 21 of the deployment device 20 to view the line that the laser 32 projects and pipe wall between the positioning device 22 and the end cap 25 of the inflatable section 21. Once the laser 32 is directly pointing to the joint—the camera 30 picks up the disappearance/displacement of the laser 32 within the joint—the deployment device 20 can be pulled a known distance so that the expandable sleeve 4 is pulled to the place where it needs to be applied in order to completely cover the joint.

The deployment device 20 also provides an umbilical cable 31 for transferring information from and to the camera 30. The umbilical cable 31 can also be used for moving the deployment device 20 through the pipe. The umbilical cable 31 is connected to the positioning device 22. The device 20 provides an airline 33 for inflating and deflating the inflatable section 21, which is connected to the inflatable section 21, and a steel cable 34, which is also connected to the inflatable section 21. By providing a steel cable 34 and an umbilical cable 31 on opposite sides of the deployment device 20 it is possible to move the device in two directions inside of the pipe.

FIG. 13 is a three dimensional view of the deployment device 20 according to the invention and shows the connection between the inflatable section 21 and the positioning section 22. The two rods 23 can be seen. They may for example be threaded rods that are screwed into holes inside of the carrier 29 and the end cap 25 facing the positioning section 22. The two rods are positioned adjacent each other on one radial side of the deployment device 20 to allow some movement of the two sections relative to each other.

FIGS. 11 and 12 are cross-sectional, schematic views of the inflatable section 21 of a deployment device according to the invention inside of a pipe at the location of a pipe joints of two pipes 1 and 2. As can be seen in the drawings, the pipes 1 and 2 are not ideally aligned. In FIG. 11 the two pipes provide an angled offset of an angle α, wherein α may for example be 5 degree. In FIG. 12 the two pipes provide an offset b, wherein b may for example be 10 mm.

As can be seen in the two drawings, and as is not limited to the embodiments shown in the drawings but refers to the invention in general, in order to avoid that the expandable sleeve that is being transported through the pipe touches the inside of any of the pipes or the total length as well as the diameter of the inflatable section during transport play an important role. The longer the inflatable section is, the smaller the diameter needs to be selected. But there is a limit to minimizing the diameter of the inflatable section because if the process according to the invention starts with a too small diameter, the expandable sleeve may be expanded to much during the further process steps such that it does not reliably stick to the inside of the wall anymore. In order to be able to move the deployment device with the adhesive sleeve through a pipe the invention provides the following features: some of the technical features needed to position the deployment device inside of the pipe have been mounted on a section that is separate from the inflatable section. In addition, the two sections are connected with each other such that they can move relative to each other, which provides more flexibility to the entire deployment device.

1. An in-situ deployment device for transporting an expandable sleeve inside of a pipe and for applying it on the inside of the pipe, wherein the expandable sleeve comprises a backing layer and an adhesive layer and wherein the adhesive layer faces the outside when the sleeve is positioned on the deployment device while being transported through the pipe, the deployment device comprising:
an inflatable section for carrying and expanding the expandable sleeve and
a positioning section for positioning the deployment device at the correct location inside of the pipe,
wherein the inflatable section and the positioning section are connected such with each other that the two sections can move relative to each other.

2. Deployment device according to claim 1, wherein the inflatable section and the positioning section are connected with each other by at least one rod.

3. Deployment device according to claim 1, wherein the inflatable section and the positioning section are connected with each other by two rods, wherein the two rods are positioned adjacent each other on one radial side of the deployment device.

4. Deployment device according to claim 1, wherein the positioning section comprises a camera and optionally a light source.

5. Deployment device according to claim 1, wherein the positioning section comprises means for centering the positioning section.

6. Deployment device according to claim 1, wherein the inflatable section comprises an inflatable bladder and two end caps one on each side of the inflatable section.

7. Deployment device according to claim 1, wherein the dimensions of the inflatable section are selected such that the deployment device is suitable to transport the expandable sleeve with the adhesive layer facing to the outside through a pipe without the expandable sleeve touching the inside of the pipe.

8. Deployment device according to claim 6, wherein the inflatable bladder comprises a diameter of less than 70% of the inner diameter (d) of the pipe when being moved with the expandable sleeve towards the location that needs to be sealed.

9. Deployment device according to claim 1, wherein the inflatable section comprises end caps with means for centering the inflatable section.

10. Deployment device according to claim 1, wherein the inflatable section comprises at least one end cap with a laser positioning system.

11. Deployment device according to claim 1, wherein the camera of the positioning device is directed towards the laser positioning system.

12. Deployment device according to claim 1, wherein the deployment device comprises an umbilical cable for transferring information and for moving the device inside of the pipe.

13. Deployment device according to claim 1, wherein the deployment device comprises a steel cable for moving the device inside of the pipe.

14. Deployment device according to claim 1, wherein the deployment device comprises an airline for transporting air through the pipe for inflating or deflating the inflatable section.

15. Deployment device according to claim 1, wherein cushioning elements are used as centering means for the positioning section and/or the inflatable section.
